(19) United States
(12) Patent Application Publication
(10) Pub. No.: US 2005/0149720 A1
(43) Pub. Date: Jul. 7, 2005

(54) Method for speeding up the pass time of an executable through a checkpoint

(76) Inventors: Shimon Gruper, (US); Yanki Margalit, Ramat-Gan (IL); Dany Margalit, Ramat-Gan (IL)

Correspondence Address: DR. MARK FRIEDMAN LTD.;C/o Bill Polkinghorn, Discovery Dispatch, 9003 Florin Way, Upper Marlboro, MD, 20772, US

(21) Appl. No.: 10/751,986

(22) Filed: Jan. 7, 2004

(51) Int. Cl. H04L 9/00

(52) U.S. Cl. 713/153

(57) ABSTRACT

A method for speeding up the pass time of an executable (an HTML file, a script file, a web page, an EXE file, an email message, and so forth) through a checkpoint (e.g. a gateway) in which the integrity of said executable is being tested, said method comprising: receiving and accumulating the parts of said executable that reach to said checkpoint; testing the integrity of the accumulated parts; releasing and sending the accumulated parts that have been indicated as harmless to their destination in an accelerated manner; releasing and sending the accumulated parts that have not been indicated as harmless or malicious to their destination in a moderate manner; and upon indicating the maliciousness of said accumulated parts, performing an alert procedure. According to a preferred embodiment of the invention, receiving and/or sending data is carried out at the lower levels of the OSI model, especially at the Network level.

### FIELD OF THE INVENTION

The present invention relates to the-field of malicious content detection. More particularly, the present invention relates to method for speeding up the transfer time of an executable through a checkpoint (e.g. a gateway) in which the integrity of said executable is being tested:

### BACKGROUND OF THE INVENTION

The term “gateway” refers in the art to a bridge between two networks. For each network, the gateway is a point that acts as an entrance to another network. From the implementation point of view, a gateway is often associated with both a router, which knows where to direct a given packet that arrives to the gateway, and a switch, which provides to a packet the actual path in and out of the gateway. Due to its nature, the gateway to a local network is a proper point for checking out files that pass through it, in order to detect viruses and other forms of maliciousness (“inspection”) before reaching the user.

Since the inspection process takes time, the inspection has a substantial influence on the traffic speed through checkpoint, e.g. a gateway. U.S. patent application Ser. No. 10/002,407, titled as Security Router, deals with the speed problem by skipping the inspection of trusted files. According to this invention, since multimedia files (e.g. JPG files) do not comprise executable code (according to their definition), the inspection can skip these files and thereby diminish the delay caused by the inspection process.

In this regard, files that comprise executable code are divided into two categories: files that should be fully accessible by an inspection facility during the inspection process and files that may be partially accessible by an inspection facility during the inspection process, e.g. HTML files. Files that should be fully accessible for inspection (referred herein as FA files), may cause a substantial delay to the traffic through a checkpoint since the inspection can start only after the whole file is accessible to the inspection facility. U.S. patent application Ser. No. 09/498,093, titled as “Protection of computer networks against malicious content”, deals with the delay problem by holding in a checkpoint only the last packet of a file, and releasing it once the file has been indicated as harmless.

The present invention deals with executable files that may be partially accessible by the inspection facility during the inspection process, like HTML files. These files are referred herein as PA files. In the case of PA files, holding the last packet at the checkpoint would not be a proper solution, since HTML files are executed/displayed by the browser at the moment the first packet arrives to the user's machine, and therefore if they comprise malicious executable content, the malicious executable may start to operate before the last packet arrives. Holding the whole file at the gateway also would not be a proper solution since the delay may be interpreted by the user as communication problems.

It is therefore an object of the present invention to provide a method for speeding up the pass time of an executable, especially PA files, through a checkpoint in which the integrity of said executable is being tested.

Other objects and advantages of the invention will become apparent as the description proceeds.

### SUMMARY OF THE INVENTION

A method for speeding up the pass time of an executable (an HTML file, a script file, a web page, an EXE file, an email message, and so forth) through a checkpoint (e.g. a gateway) in which the integrity of said executable is being tested, said method comprising: receiving and accumulating the parts of said executable that reach to said checkpoint; testing the integrity of the accumulated parts; releasing and sending the accumulated parts that have been indicated as harmless to their destination in an accelerated manner; releasing and sending the accumulated parts that have not been indicated as harmless or malicious to their destination in a moderate manner; and upon indicating the maliciousness of said accumulated parts, performing an alert procedure. According to a preferred embodiment of the invention, receiving and/or sending data is carried out at the lower levels of the OSI model, especially at the Network level.

### BRIEF DESCRIPTION OF THE DRAWINGS

The present invention may be better understood in conjunction with the following figures:

FIG. 1 schematically illustrates a system that may be used for implementing the present invention.

FIG. 2 is a flowchart of a process of testing the integrity of a PA file in a checkpoint, according to a preferred embodiment of the invention.

FIG. 3a is a flowchart of a sub-process in which the packets that reach to the checkpoint are accumulated in a repository, according to a preferred embodiment of the invention.

FIG. 3b is a flowchart of a sub-process in which the data present in the repository is inspected, according to a preferred embodiment of the invention.

FIG. 3c is a flowchart of a sub-process in which the data that has been indicated as harmless is transferred to the destination, according to a preferred embodiment of the invention.

### DETAILED DESCRIPTION OF PREFERRED EMBODIMENTS

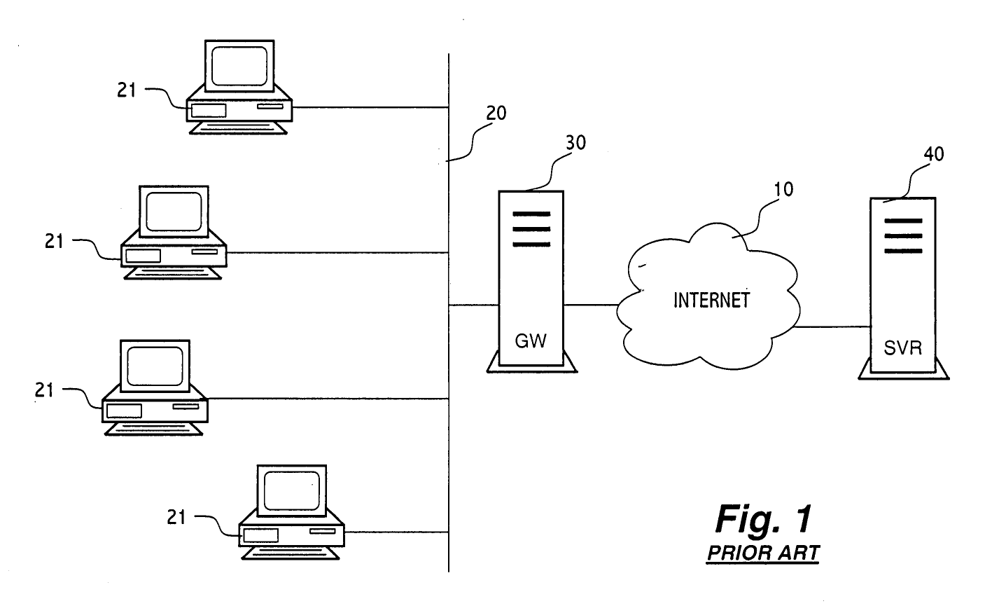

FIG. 1 schematically illustrates a system that may be used for implementing the present invention. The computers 21 are connected to the local area network 20. The local area network 20 is connected to the internet 10. The gateway server 30 is interposed between the local area network 20 and the internet 10. The internet server 40 hosts web sites. A browser being executed on a computer 21 that addresses to the web site hosted by the internet server 40 cause files to be transferred from the internet server 40 to the computer 21 through the gateway server 30.

OSI, the acronym of Open System Interconnection (OSI), is a standard that defines how messages are transmitted between two points in a telecommunication network. OSI divides telecommunication into seven layers. The upper four layers (4 to 7) define how-a message passes from or to a user. The lower three layers (1 to 3) are used when any message passes through a host computer.

The seven layers of the OSI model are:
Layer 7, the Application layer, which deals with services to the applications;
Layer 6, the Presentation layer, which converts the information;
Layer 5, the Session layer, which handles problems which are not communication issues;
Layer 4, the Transport layer, which provides end to end communication control;
Layer 3, the Network layer, which routes the information in the network
Layer 2, the Data Link layer, which provides error control between adjacent nodes; and
Layer 1, the Physical layer, which connects the entity to the transmission media.

Layer 7, the Application layer, provides services to the applications that are specifically directed to run over the network. It is implemented at the gateway, and supports protocols such as DNS; FTP, SMTP and SNMP.

Layer 3, the Network layer, routes the information in a network, i.e. mainly translates logical network address and names to their physical address. For example, if a router cannot send data frame as large as the source computer sends, the network layer compensates by breaking the data into smaller units. It is implemented by routers, switches, etc. and supports protocols such as IP, IPE, and OSI.

With regard to the present invention, the difference between the Application layer and the Network layer is the type of the accessible data. More specifically, while a program being executed at the Application layer of OSI can access files, a program executed at the Network layer can access packets.

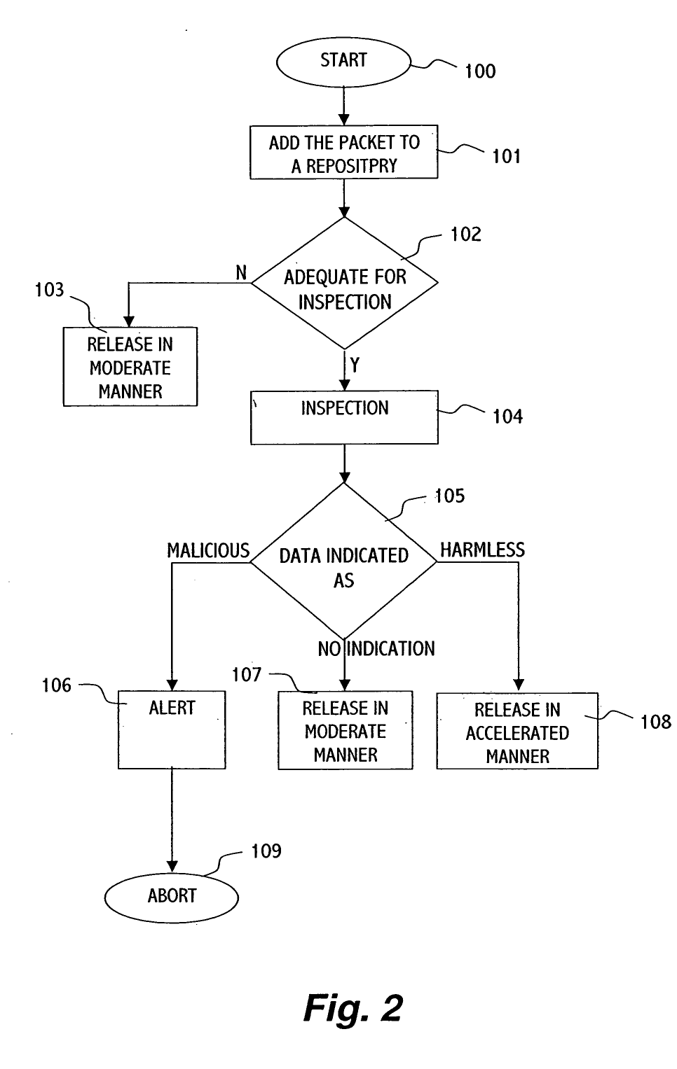

FIG. 2 is a flowchart of a process for testing the integrity of a PA file in a checkpoint, according to a preferred embodiment of the invention.

Passing data between the OSI layers is not meaningful when dealing with a single file, but when dealing with thousands of files, as in a server that filters the data entered to an organization, such a delay has an impact on the performance of the server. Therefore, implementing the method at the lower levels of the OSI model, e.g. the Network layer, diminishes the delay caused by inspecting the data. However, it should be noted that the method described herein can be implemented in other layers of the OSI model. Thus, although the reference made herein is to packets, the method can be implemented also by forms of data which are available under the OSI model, e.g. data chunks.

The process starts at block 100, when a packet of a PA file, e.g. an HTML file, is received at a checkpoint.

At block 101, the packet is added to a repository, e.g. a memory buffer. Since the data enclosed within one packet may not be adequate for inspection and also since the packets do not necessarily have to reach the checkpoint in the same order they have been sent, the data should be temporarily stored within a repository, until the accumulated data is available for inspection.

Typically, a packet has two kinds of information—the raw data, and header, which comprises information such as the IP destination address and the IP source address of the packet, the position of the raw data in the file, etc. The size of an output packet from a checkpoint does not necessarily have to be the same as the size of the input packet. Actually, the output data can be divided into packets of different size as compared to their corresponding input packets. For example, a packet of 100 data bytes that enters into a gateway can be released by two packets of 50 bytes. Moreover, the output packet can be constructed from data of adjacent packets, etc.

From block 102, if the data stored within the repository is adequate for inspection, then the process continues with the inspection process 104. Obviously, the inspection can be carried out only on the data available at the repository. If the data stored within the repository is not adequate for inspection, the data is released in a moderate manner 103, as will be described later.

Those skilled in the art will appreciate that there are a variety of methods for detecting maliciousness of an HTML file. For example, an HTML file may contain objects of several types: HTML commands, script language text (like VBScript and JavaScript), active content commands (like ActiveX and Java applets), etc. These objects may be divided to “sub-objects”, e.g. functions in a script language. An object can be considered as suspicious if according to its definition it can alter a file or the content of the computer's memory. Some of the objects may contain malicious content (e.g. ActiveX commands), and consequently considered as suspicious, while other objects cannot be malicious (e.g. HTML commands). Usually, the maliciousness of each object can be tested separately. While the chunks of data arrive to a checkpoint, the HTML file is parsed to its objects. When an object is completely available on the checkpoint, its maliciousness can be tested. If the object cannot contain malicious content by its definition, or has been tested and found as “innocent”, then it can be transmitted to its destination.

From block 105:
If the tested data is not sufficient for indication or cannot be indicated neither as harmless nor as malicious, the process continues with block 107, where the data stored in the repository is sent to the destination in a moderate manner, in order to satisfy two objects—on the one hand not to cause a timeout error, on the other hand not to allow the receiver (e.g. a browser) to receive executable data that has not been yet indicated as harmless. This can be carried out by a variety of ways, such as periodically sending a small amount of data (e.g. a packet with 1 byte of data) after a deliberate delay, etc.
If the tested data is indicated as malicious, then the process continues with block 106, where an alert procedure is performed, and typically the transfer of the HTML file to its destination is aborted 109.
However, if the data stored within the repository is indicated as harmless, then the process continues with block 108, where the checked data is sent to the destination in an accelerated manner, in order to speed up the transfer of trusted data to its destination. This can be carried out in a variety of ways, such as constructing bigger packets and sending the data without delay.

Generally speaking, when a packet is sent from a source to a destination, an acknowledgement regarding the reception of the packet should be received by the source within a predetermined period otherwise the source interprets the delay as communication problems, and resends the packet to its destination. Thus, a facility interposed between the source and the destination (e.g. a checkpoint) in order to delay the packet should communicate with both the source and the destination. The interposed facility communicates with the source and sends an acknowledgement of reception of the packet at the destination, and communicates with the destination at the time the packet will be sent. In order to communicate with both the source and the destination, the interposed facility “masquerades”. It communicates with the source while “pretending” to be the destination, and communicates with the destination while “pretending” to be the source. Those skilled in the art will appreciate that this technique is well known in the art, and implemented in a variety of network inspection facilities, like the eSafe Appliance of Aladdin Knowledge Systems.

Block 107 deals with “releasing” the data that enters to the checkpoint in a moderate manner. On the one hand the packet should be delayed at the checkpoint until the integrity of its data will be determined; on the other hand the delay may cause a timeout error. According to the present invention, this conflict can be solved by releasing small amounts of data within the allowed period (according to the transfer rules of the network). For example, a packet of 1024 bytes of data is reconstructed as 1024 packets of 1 byte each. Since each packet has supplemental data, like the source of the packet, the destination, its size, etc., sending 1024 packets of one byte takes longer than sending one packet of 1024 bytes.

This is one solution to sending data in a “moderate” manner. Actually sending data in a moderate manner can be carried out by a variety of ways. For example, instead of sending received data packets immediately after their reception at the checkpoint, the packets are sent periodically, such that a period is smaller than the timeout limit in the communication network. Of course a packet can be sent immediately, but a deliberate delay can be inserted between two consecutive packets. Moreover, by sending a small amount of data (e.g. a packet with 1 byte of data), the overhead is increased, and therefore the transfer rate is decreased. In readable files, like HTML, a dummy data can be inserted, like HTML remarks. This way while the communication session continues, no executable code is reached to the browser, until the content is indicated as harmless.

From the implementation point of view, there are several processes that can be carried out in parallel: getting the packets from the source, the inspection process, and releasing the packets to the destination.

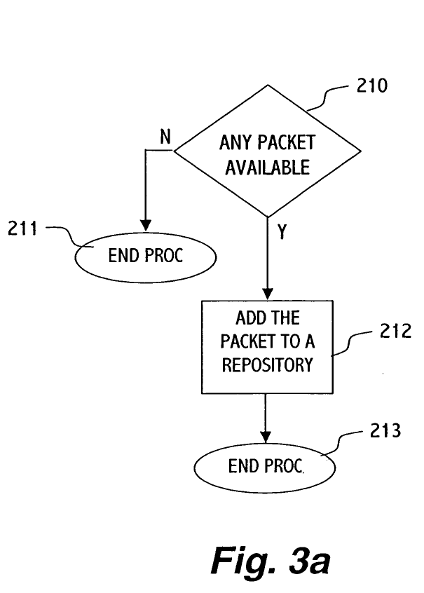

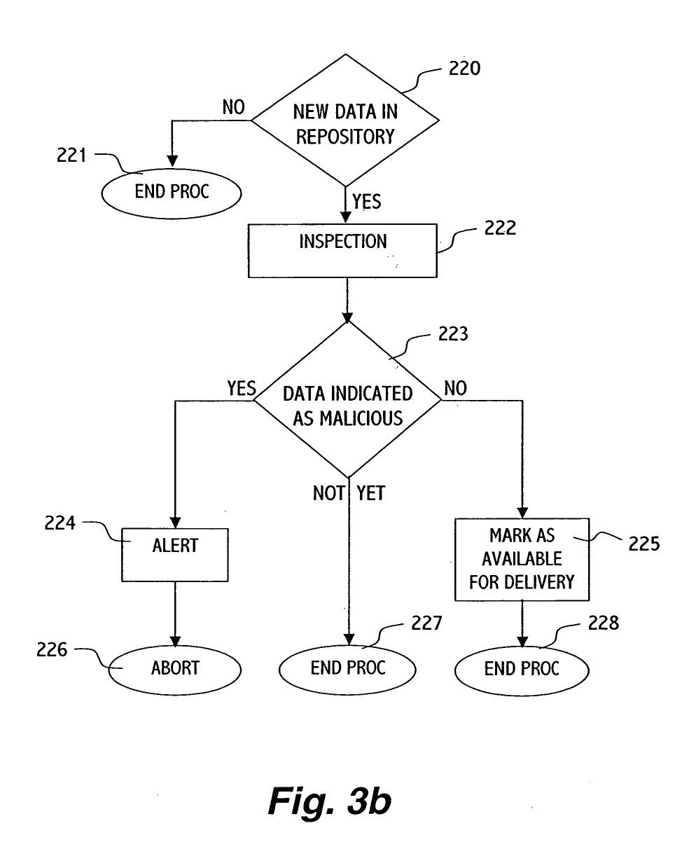

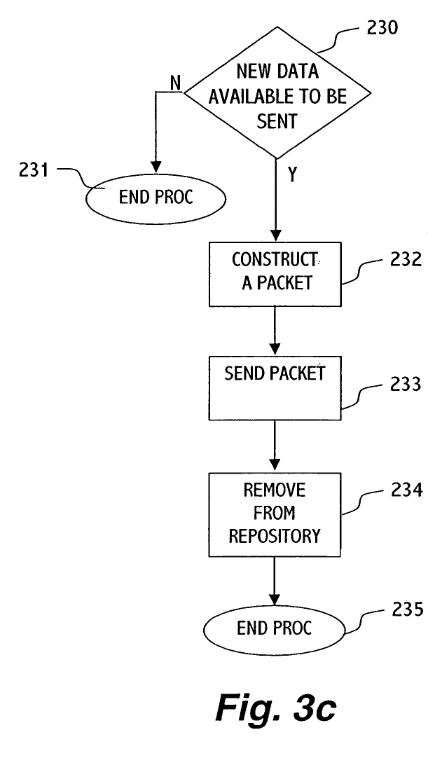

FIG. 3a is a flowchart of the first process, wherein the server operating at the checkpoint looks for new packets of the tested file that have been received 210 at a checkpoint, and in case of positive answer, the raw data of the new packets is added 212 to a repository. The first sub-process ends after the new packets have been added 213 to the repository, or if no new packets of the tested file are available 211.

FIG. 3b is a flowchart of the second process, wherein if new data is available in the repository 220 then the data within the repository is inspected 222. From 223, if the inspected data is indicated as malicious, then an alert procedure is invoked 224, and then the transfer of the file may abort 226. If from 223 the inspected data is indicated as harmless then some data, typically the inspected data, is marked as available to be sent to the destination 225. The sub process ends if no new packets are available at the repository 221; after sending the data that has been indicated as harmless to the destination 228; or if the data in the repository couldn't be inspected 227.

FIG. 3c is a flowchart of the third process, wherein from 230 if new data is available to be sent to the destination, then the available data is constructed as packets 232, which are sent to the destination 233. Then the sent data is removed from the repository, etc. 234. The third process ends if no new data to be sent to the destination is available 231, or after the available data has been sent 235.

The invention may be implemented also to FA files, or any other kind of files. Actually the invention may be implemented whenever a file transferred from a source to a destination should be delayed at a point between the source and the destination without breaking the transfer rules (e.g. timeout).

Those skilled in the art will appreciate that the invention can be embodied by other forms and ways, without losing the scope of the invention. The embodiments described herein should be considered as illustrative and not restrictive.

1. A method for speeding up the pass time of an executable through a checkpoint in which the integrity of said executable is being tested, said method comprising:
receiving and accumulating at least one part of said executable that reaches to said checkpoint;
testing the integrity of said at least one part of said executable;
releasing at least one accumulated part whose integrity has been verified to its destination in an accelerated manner;
releasing and sending at least one accumulated part to its destination in a moderate manner; and
upon indicating the non-integrity of said at least one part, performing an alert procedure.

2. A method according to claim 1, wherein said moderate manner is carried out by operations selected from the group consisting of: dividing packets to be sent to smaller packets thereby increasing the overhead of sending said packets, inserting a delay between two consecutive send operations, sending the data to be sent periodically instead of immediately, and sending dummy commands.

3. A method according to claim 1, wherein said accelerated manner is carried out by operations selected from the group consisting of: combining a plurality of data packets to one packet thereby decreasing the overhead of sending said packets, and sending the available data once said data has been indicated as harmless.

4. A method according to claim 1, wherein said alert procedure is selected from the group consisting of: aborting sending said executable to said destination, alerting the operator of the server of said checkpoint, alerting said destination, and alerting said source.

5. A method according to claim 1, wherein said at least one part includes a data packet.

6. A method according to claim 1, wherein said receiving is carried out in at least one lower level of the OSI model.

7. A method according to claim 8, wherein said at least one lower level is the Network layer of the OSI model.

8. A method according to claim 1, wherein said sending is carried out in at least one lower level of the OSI model.

9. A method according to claim 10, wherein said at least one lower level is the Network layer of the OSI model.
